(19) United States
(12) Patent Application Publication
(10) Pub. No.: US 2006/0185452 A1
(43) Pub. Date: Aug. 24, 2006

(54) Lead frame, sensor including lead frame, resin composition to be used for resin mold in the sensor, and sensor including the resin mold

(75) Inventors: Kenichi Shirasaka, Hamamatsu-shi (JP); Hiroshi Saitoh, Iwata-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: Yamaha Corporation

(21) Appl. No.: 11/356,396

(22) Filed: Feb. 17, 2006

(30) Foreign Application Priority Data
Feb. 22, 2005 (JP) P2005-045297
Aug. 29, 2005 (JP) P2005-247497

(51) Int. Cl. G01D 21/00

(52) U.S. Cl. 73/866.5

(57) ABSTRACT

A lead frame includes a frame body defining an internal region; a plurality of leads extending from the frame body; a first stage disposed in the internal region; and a first modified connection lead structure comprising a flexible portion connected to the first stage and a modified connection lead connecting the flexible portion to the frame body. The modified connection lead has sloped side walls that permit a molten resin to flow into and fill up a small gap around the modified connection lead to form a void-free resin mold that encapsulates a sensor chip included in a sensor.

### BACKGROUND OF THE INVENTION

1. Field of the Invention

The present invention generally relates to a sensor for sensing the direction or the azimuth of a physical quantity such as a magnetic field or gravity, a lead frame to be used for a resin mold in the sensor, a resin composition to be used for a resin mold in the sensor and a sensor including the resin mold.

Priority is claimed on Japanese Patent Application No. 2005-45297, filed Feb. 22, 2005, and Japanese Patent Application No. 2005-247497, filed Aug. 29, 2005, the contents of which are incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In recent years, terminal devices have been developed such as mobile phones with a GPS (Global Positioning System) function, which indicates information about a user's position. The terminal device may have an additional function of sensing or measuring geomagnetic field or acceleration, thereby sensing or measuring the azimuth or direction in a three-dimensional space of a user's terminal device or a motion of the terminal device.

In order to provide the terminal device with the above-described additional function, it is necessary to integrate the terminal device with one or more sensors such as magnetic sensors or acceleration sensors. In order to allow the sensor to detect the azimuth or acceleration in the three-dimensional space, it is necessary for the sensors to be sloped so that a first one of the sensors tilts from a second one. The sensors are mounted on stages that are included in a lead frame. Thus, the stages are also sloped so that a first one of the stages tilts from a second one.

A wide variety of sensors that sense physical quantities have been developed. A typical example of the sensor may include, but is not limited to, a magnetic sensor that senses a magnetic field. This magnetic sensor is different from the above-described sensor. This magnetic sensor has a substrate and magnetic sensor chips that are disposed on a surface of the substrate. The magnetic sensor includes first and second magnetic sensor chips that are mounted on the substrate. The first magnetic sensor chip extends parallel to the surface of the substrate. The second magnetic sensor chip extends vertically to the surface of the substrate. The first magnetic sensor chip senses first and second magnetic components of an external magnetic field. The first magnetic component is a component in a first direction that is parallel to the surface of the substrate. The second magnetic component is another component in a second direction that is parallel to the surface of the substrate and is perpendicular to the first direction. The second magnetic sensor chip senses a third magnetic component of the external magnetic field. The third magnetic component is still another component in a third direction that is vertical to the surface of the substrate and also vertical to the first and second directions. The magnetic sensor utilizes a pair of the first and second magnetic sensor chips to detect a three-dimensional vector that represents the geomagnetic field. As described above, the second magnetic sensor chip extends vertically to the surface of the substrate. This increases a thickness of the magnetic sensor that includes the first and second magnetic sensors. The thickness is defined as a dimension or a size of the magnetic sensor in a direction vertical to the surface of the substrate.

In order to reduce the thickness of the magnetic sensor, it is possible to dispose magnetic sensor chips on sloped stages that are sloped or tilted from the frame body. Japanese Unexamined Patent Applications, First Publications, Nos. 9-292408, 2002-15204, and 2004-128473 disclose examples of the conventional sensor which includes a frame body, sloped stages, and sensor chips that are mounted on the sloped stages. Japanese Unexamined Patent Application, First Publication, No. 9-292408 discloses an acceleration sensor that includes a substrate and acceleration sensor chips that are sloped or tilted from a surface of the substrate, and a packaging that is placed on the substrate. The sloped sensor is highly sensitive to an acceleration in a direction that tilts from the surface of the substrate. The sloped sensor is poorly sensitive to another acceleration in another direction that is parallel to the surface of the substrate.

FIG. 18 is a plan view illustrating a conventional example of a lead frame to be used for forming a sensor that senses a physical quantity. FIG. 19 is a fragmentary cross sectional elevation view illustrating a sensor including the lead frame of FIG. 18. A lead frame 50 includes stages 55 and 57 that respectively support sensor chips 51 and 53, a frame body 59 that surrounds the stages 55 and 57, and connection leads 61 that connect the stages 55 and 57 to the frame body 59. This lead frame 50 is used to form a sensor. The stages 55 and 57 that respectively mount the sensor chips 51 and 53 are sloped from a plane that includes the frame body 59 and the connection leads 61. The lead frame 50 is placed in a cavity of dies “P” and “Q”. A molten resin is injected into the cavity to form a resin mold that encapsulates the magnetic sensor chips 51 and 53 and the stages 55 and 57. The connection leads 61 and the frame body 59 define gaps S5. The connection leads 61 have bottom surfaces that are in contact with a surface “Q1” of the die “Q”. Accordingly, the molten resin flows into the gaps S5 from the top.

It is possible to reduce a size of the gaps S5 in order to scale down the sensor that includes the conventional lead frame 50. However, the size reduction of the gaps S5 makes it difficult to fill up the gaps S5 with the molten resin and also difficult to prevent voids from being formed in the gaps S5.

A sensor for sensing a physical quantity can be formed by the following known processes. A lead frame is prepared that includes a frame portion as a body, a plurality of leads extending from the frame portion, and stages connected to the frame portion. The stages are leveled to the frame portion. Sensor chips are bonded to the stages. The lead frame with the sensor chips is placed in a cavity defined by a pair of dies. The stages with the sensor chips are sloped down from a plane that includes the frame portion. A molten resin is injected into the cavity so as to form a resin mold that encapsulates and contains the sensor chips and the lead frame. The resin mold can protect the sensor chips from mechanical impact and moisture. The resin mold can improve heat radiativity of the sensor chips. The resin mold can also provide an electrical insulation property of the sensor chips. This is disclosed in Japanese Unexamined Patent Application, First Publication, No. 2004-128473.

Typical examples of the resin that have been known and used are epoxy resins of low molecular weight and biphenyl resins that are mixed with filler. Typical examples of the filler to be mixed into the resin include crushed crystal silica, crushed amorphous silica, and particulate amorphous silica.

As the requirements for scaling down and reducing in thickness a device such as a mobile terminal that includes the sensor chips have been on the increase, the sensor chips are required to be scaled down with further size reductions of gaps between the stages and inner walls of the dies and gaps around modified leads that connect the stages to the frame portion. The size reductions of the gaps make it difficult to fill up the gaps with the molten resin. In order to fill up such small gaps, it is possible to use a resin that has a low viscosity. The resin is further required to have a high heat conductivity and a low thermal expansion coefficient. In order to obtain the high heat conductivity, it is possible that the resin has a high content of filler that provides the heat conductivity. Increasing the content of the filler increases the viscosity. Namely, the requirement for reducing the viscosity opposes the requirement for increasing the heat conductivity.

The conventional examples of the filler to be mixed in the resin are the crushed filler or a mixture of the particulate filler with the crushed filler. The conventional filler can not fill up small gaps and allows a void or voids to be formed in the resin mold. The resin mold that contains a void or voids can not protect the sensor chips from mechanical impact and moisture. Further, the resin mold with voids can reduce the heat radiativity and deteriorates the electrical insulation property. In order to prevent the formation of voids in the resin mold, attempts to reduce the dimensions of the lead frame and to scale down the sensor have been abandoned.

When a filler contains particles that are too large to fill up small gaps, the use of such a particulate filler can allow a void or voids to be formed in the resin mold.

In order to form a void-free resin mold by using the conventional resin as described above, it is possible to increase an injection pressure in the injection molding process. However, increasing the injection pressure can cause damage to the sensor chips.

In view of the above, it will be apparent to those skilled in the art from this disclosure that there exist needs for an improved lead frame, a sensor including the improved lead frame, and an improved resin composition to be used for the sensor. This invention addresses these needs in the art as well as other needs, which will become apparent to those skilled in the art from this disclosure.

### SUMMARY OF THE INVENTION

Accordingly, it is a primary object of the present invention to provide a lead frame that senses a physical quantity.

It is another object of the present invention to provide a sensor that senses a physical quantity and includes a lead frame.

It is a further object of the present invention to provide a resin composition to be used for a sensor that senses a physical quantity and includes a lead frame.

In accordance with a first aspect of the present invention, a lead frame comprises: a frame body that defines an internal region; a plurality of leads that extend from the frame body; a first stage disposed in the internal region; and a first modified lead structure comprising a flexible portion that is connected to the first stage and at least one modified lead that connects the flexible portion to the frame body, the at least one modified lead having sloped side walls. The at least one modified lead has a width that increases in a direction of thickness of the at least one modified lead. The at least one modified lead further has a first surface that is adjacent to the sloped side walls and separates the sloped side walls from each other. The at least one modified lead has a generally trapezoidal shape in cross section. The sloped side walls permit a molten resin to flow into and fill up a small gap around the modified lead to form a void-free resin mold that encapsulates a sensor chip included in a sensor.

In accordance with a second aspect of the present invention, a resin composition to be used as a resin mold that encapsulates a device comprises: a resin material; and a filler mixed in the resin material, the filler comprising particles having a maximum particle size of 30-50 micrometers and an average particle size of 10-30 micrometers. The resin composition permits a molten resin to flow into and fill up a small gap around the modified lead and another small gap adjacent to a stage supporting a chip to form a void-free resin mold that encapsulates the chip included in the device.

These and other objects, features, aspects, and advantages of the present invention will become apparent to those skilled in the art from the following detailed descriptions taken in conjunction with the accompanying drawings, illustrating the embodiments of the present invention.

### BRIEF DESCRIPTION OF THE DRAWINGS

Referring now to the attached drawings which form a part of this original disclosure:

FIG. 1 is a plan view illustrating a lead frame with magnetic sensor chips in accordance with a first preferred embodiment of the present invention;

FIG. 2 is a fragmentary cross sectional view of a lead frame, taken along an H-H line of FIG. 1;

FIG. 3 is a fragmentary cross sectional elevation view illustrating a cross sectional shape of extension portions of the modified leads that have been formed through a lithography process;

FIG. 4 is a fragmentary cross sectional elevation view illustrating a cross sectional shape of base portions of the modified leads that have been formed through the lithography process;

FIG. 5 is a fragmentary cross sectional elevation view illustrating the lead frame in a step involved in a method of forming the magnetic sensor by using the lead frame of FIG. 1 in accordance with the first embodiment of the present invention;

FIG. 6 is a fragmentary cross sectional elevation view illustrating the lead frame in another step involved in the method of forming the magnetic sensor by using the lead frame of FIG. 1 in accordance with the first embodiment of the present invention;

FIG. 7 is a plan view illustrating a magnetic sensor formed by using the lead frame of FIG. 1;

FIG. 8 is a cross sectional elevation view, taken along an I-I line of FIG. 5 illustrating the magnetic sensor;

FIG. 9 is a fragmentary plan view illustrating a lead frame including modified leads with modified flexible portions in accordance with a second preferred embodiment of the present invention;

FIG. 10 is a fragmentary cross sectional view of the lead frame, taken along a J-J line of FIG. 9;

FIG. 11 is a fragmentary cross sectional elevation view illustrating the lead frame in a step involved in the method of forming the magnetic sensor by using the lead frame of FIG. 1 in accordance with the second embodiment of the present invention;

FIG. 12 is a fragmentary plan view illustrating a lead frame including modified leads with modified flexible portions in accordance with a first modification of the second preferred embodiment of the present invention;

FIG. 13A is a fragmentary plan view illustrating a lead frame including modified leads with modified flexible portions in accordance with a second modification of the second preferred embodiment of the present invention;

FIG. 13B is a fragmentary cross sectional elevation view, taken along a K-K line of FIG. 13A;

FIG. 14 is a fragmentary plan view illustrating a sensor for sensing a physical quantity in accordance with a third preferred embodiment of the present invention;

FIG. 15 is a fragmentary cross sectional elevation view illustrating the sensor of FIG. 14;

5 FIG. 16 is a fragmentary plan view illustrating a lead frame to be used for forming the sensor of FIG. 14;

FIG. 17A is a fragmentary cross sectional elevation view illustrating the lead frame in a step involved in a method of forming the sensor by using the lead frame of FIG. 16 in accordance with the third embodiment of the present invention;

FIG. 17B is a fragmentary cross sectional elevation view illustrating the lead frame in another step involved in a method of forming the sensor by using the lead frame of FIG. 16 in accordance with the third embodiment of the present invention;

FIG. 17C is a fragmentary cross sectional elevation view illustrating the lead frame in still another step involved in a method of forming the sensor by using the lead frame of FIG. 16 in accordance with the third embodiment of the present invention;

FIG. 18 is a plan view illustrating a conventional example of a lead frame to be used for forming a sensor that senses a physical quantity; and

FIG. 19 is a fragmentary cross sectional elevation view illustrating a sensor including the lead frame of FIG. 18.

### DETAILED DESCRIPTION OF THE INVENTION

Selected embodiments of the present invention will now be described with reference to the drawings. It will be apparent to those skilled in the art from this disclosure that the following descriptions of the embodiments of the present invention are provided for illustration only and not for the purpose of limiting the invention as defined. by the appended claims and their equivalents.

### First Embodiment

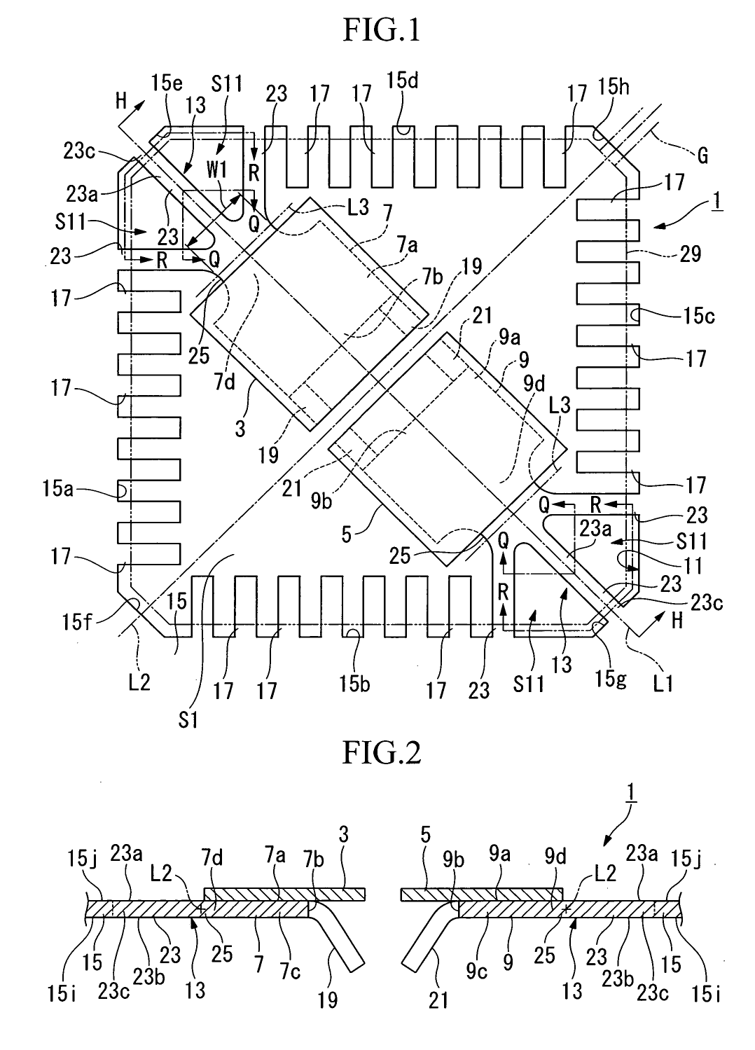

FIG. 1 is a plan view illustrating a lead frame with magnetic sensor chips in accordance with a first preferred embodiment of the present invention. FIG. 2 is a fragmentary cross sectional view of a lead frame, taken along an H-H line of FIG. 1. A sensor for sensing a physical quantity can be realized by using a lead frame on which a plurality of sensor chips for sensing a physical quantity are mounted. A typical example of the sensor for sensing a physical quantity may include, but is not limited to, a magnetic sensor for sensing the direction and the magnitude of a magnetic field.

A magnetic sensor in accordance with this embodiment of the present invention comprises a lead frame 1 and two magnetic sensor chips 3 and 5 that are mounted on the lead frame 1. Each of the two magnetic sensor chips 3 and 5 measures the direction and the magnitude of an external magnetic field that is applied to the magnetic sensor. The lead frame 1 can be formed by processes for pressing and etching a metal plate such as a copper thin plate.

As shown in FIGS. 1 and 2, the lead frame 1 includes two stages 7 and 9 on which the magnetic sensor chips 3 and 5 are mounted, respectively. Each of the two stages 7 and 9 has a square shape in plan view. The lead frame 1 further includes a frame 11 that mechanically supports the two stages 7 and 9. The lead frame 1 furthermore includes connections 13, each of which mechanically connects each of the stages 7 and 9 to the frame 11. The stages 7 and 9, the connections 13 and the frame 11 are integrated to form a monolithic structure.

The frame 11 further includes a square frame portion 15 and a plurality of leads 17. The square frame portion 15 has a generally square shape. For example, the square frame portion 15 has four sides 15a, 15b, 15c and 15d that define an internal region S1. Thus, the internal region S1 has a generally square shape. The stages 7 and 9 are positioned in the internal region S1. The square frame portion 15 encompasses the stages 7 and 9. The leads 17 extend inwardly from the four sides 15a, 15b, 15c and 15d of the square frame portion 15.

The plurality of leads 17 comprise first to fourth sub-pluralities of leads 17 that extend inwardly from the first to fourth sides 15a, 15b, 15c, and 15d of the square frame portion 15, respectively. The leads 17 are electrically connected to bonding pads of the magnetic sensor chips 3 and 5. The bonding pads are not illustrated in the drawings.

The two stages 7 and 9 have surfaces 7a and 9a on which the magnetic sensor chips 3 and 5 are mounted, respectively. Each of the surfaces 7a and 9a has a generally square shape in plan view. The square frame portion 15 has first to fourth corners 15e, 15f, 15g and 15h. The first side 15a extends between the first and second corners 15e and 15f. The second side 15b extends between the second and third corners 15f and 15g. The third side 15c extends between the third and fourth corners 15g and 15h. The fourth side 15d extends between the fourth and first corners 15h and 15e. The square frame portion 15 further has a first surface 15i and a second surface 15j that is opposite to the first surface 15i.

The square frame portion 15 defines first and second diagonal lines L1 and L2 that cross each other at a right angle. The first diagonal line L1 extends between the first and third corners 15e and 15g. The second diagonal line L2 extends between the second and fourth corners 15f and 15h. The first and third corners 15e and 15g are positioned symmetrically to each other with reference to the reflection-symmetric axis of the second diagonal line L2. The second and fourth corners 15f and 15h are positioned symmetrically to each other with reference to the reflection-symmetric axis of the first diagonal line L1. The stages 7 and 9 are positioned near the first and third corners 15e and 15g, respectively. The stages 7 and 9 have center lines which overlap the first diagonal line L1. The stages 7 and 9 are placed at positions that are symmetrical to each other with reference to the reflection-symmetric axis of the second diagonal line L2. The stages 7 and 9 are disposed symmetrically to each other with reference to the reflection-symmetric axis of the second diagonal line L2. The stages 7 and 9 are distanced from the second diagonal line L2. Each of the stages 7 and 9 extends two-dimensionally and symmetrically with reference to the reflection-symmetric axis of the first diagonal line L1.

As shown in FIG. 2, the stage 7 has the first surface 7a and a second surface 7c that is opposite to the first surface 7a. The stage 7 further has a center line that is aligned to the first diagonal line L1. As described above, the stage 7 has the generally square shape. The stage 7 has four sides, where two sides 7b and 7d are parallel to the second diagonal line L2 and perpendicular to the first diagonal line L1, while the remaining two sides are parallel to the first diagonal line L1 and perpendicular to the second diagonal line L2. The side 7b is proximal to the second diagonal line L2 but is distal from the first corner 15e of the square frame portion 15. The opposite side 7d is proximal to the first corner 15e and is distal from the diagonal line L2. The four sides of the stage 7 are not parallel to nor perpendicular to the four sides 15a, 15b, 15c and 15d of the square frame portion 15.

Two projecting parts 19 extend from the bottom surface 7c in a direction vertical to a plane that includes the first and second diagonal lines L1 and L2. Preferably, the projecting parts 19 extend from positions adjacent to the side 7b of the stage 7. The two projecting parts 19 are distanced from each other and positioned symmetrically to each other with reference to the reflection-symmetric axis of the first diagonal line L1. The projecting parts 19 distanced from each other prevent the stage 7 from being twisted around the first diagonal line L1 in a process to make the stage 7 sloped.

As shown in FIG. 2, the stage 9 has the first surface 9a and a second surface 9c that is opposite to the first surface 9a. The stage 9 further has a center line that is aligned to the first diagonal line L1. As described above, the stage 9 has the generally square shape. The stage 9 has four sides, where two sides 9b and 9d are parallel to the second diagonal line L2 and perpendicular to the first diagonal line L1, while the remaining two sides are parallel to the first diagonal line L1 and perpendicular to the second diagonal line L2. The side 9b is proximal to the second diagonal line L2 but is distal from the third corner 15g of the square frame portion 15. The opposite side 9d is proximal to the third corner 15g and is distal from the diagonal line L2. The four sides of the stage 9 are not parallel to nor perpendicular to the four sides 15a, 15b, 15c and 15d of the square frame portion 15.

Two projecting parts 21 extend from the second surface 9c in a direction vertical to a plane that includes the first and second diagonal lines L1 and L2. Preferably, the projecting parts 21 extend from positions adjacent to the side 9b of the stage 9. The two projecting parts 21 are distanced from each other and positioned symmetrically to each other with reference to the reflection-symmetric axis of the first diagonal line L1. The projecting parts 21 distanced from each other prevent the stage 9 from being twisted around the first diagonal line L1 in a process to make the stage 9 sloped.

First to fourth pluralities of leads 17 extend inwardly from the first to fourth sides 15a, 15b, 15c and 15d of the square frame portion 15, respectively. Each of the stages 7 and 9 is connected to the square frame portion 15 through the connections 13. Each of the connections 13 comprises a flexible portion 25 and first to third modified connection leads 23. Namely, a first one of the connections 13 comprises the flexible portion 25 that extends adjacent to the side 7d of the stage 7, and the first to third modified connection leads 23 that connect the flexible portion 25 to the square frame portion 15. The first to third modified connection leads 23 are longer than the leads 17. The first modified connection lead 23 extends along the first diagonal line L from the first corner 15e of the square frame portion 15 to the center of the side 7d of the stage 7. The second modified connection lead 23 extends from the fourth side 15d of the square frame portion 15 to a first corner of the flexible portion 25. The second modified connection lead 23 extends in parallel to the fourth plurality of leads 17 that extend from the fourth side 15d of the square frame portion 15. The third modified connection lead 23 extends from the first side 15a of the square frame portion 15 to a second corner of the flexible portion 25, which is opposite to the first corner. The third modified lead 23 extends in parallel to the first plurality of leads 17 that extend from the first side 15a of the square frame portion 15. The first modified lead extends between the second and third modified connection leads 23.

The flexible portion 25 has a width “W1” which is narrower than the stage 7 but wider than the first to third modified connection leads 23. The flexible portion 25 may have, but does not have to have, the same thickness as the stage 7 and the projecting parts 19. The first to third modified connection leads 23 may also have, but do not have to have, the same thickness as the flexible portion 25. Alternatively, the flexible portion 25 may be, but does not have to be, thinner than the stages 7 and 9 and the modified connection leads 23. The reduction in thickness of the flexible portion 25 increases the flexibility thereof and reduces the mechanical strength thereof. The reduction in thickness of the flexible portion 25 may be obtained by half-etching the flexible portion 25.

The first modified connection lead 23 extends between the second and third modified connection leads 23. The first and second modified connection leads 23 and the fourth side 15d define a first gap S11. In other words, the first gap S11 is encompassed by the first and second modified connection leads 23 and the fourth side 15d. The first and third modified connection leads 23 and the first side 15a define a second gap S11. In other words, the second gap S11 is encompassed by the first and third modified connection leads 23 and the first side 15a.

A second one of the connections 13 also comprises a flexible portion 25 that extends adjacent to the side 9d of the stage 9, and fourth to sixth modified connection leads 23 that connect the flexible portion 25 to the square frame portion 15. The fourth to sixth modified connection leads 23 are longer than the leads 17. The fourth modified connection lead 23 extends along the first diagonal line L from the third corner 15g of the square frame portion 15 to the center of the side 9d of the stage 9. The fifth modified connection lead 23 extends from the second side 15b of the square frame portion 15 to a first corner of the flexible portion 25. The fifth modified connection lead 23 extends in parallel to the second plurality of leads 17 that extend from the second side 15b of the square frame portion 15. The sixth modified connection lead 23 extends from the third side 15c of the square frame portion 15 to a second corner of the flexible portion 25 that is opposite to the first corner. The sixth modified connection lead 23 extends in parallel to the third plurality of leads 17 that extend from the third side 15a of the square frame portion 15. The fourth modified connection lead 23 extends between the fifth and sixth modified connection leads 23.

The flexible portion 25 has a width “W1” which is narrower than the stage 9 but wider than the fourth to sixth modified connection leads 23. The flexible portion 25 has the same thickness as the stage 9 and the projecting portions 21. The fourth to sixth modified connection leads 23 have the same thickness as the flexible portion 25.

The fourth modified connection lead 23 extends between the fifth and sixth modified connection leads 23. The fourth and fifth modified connection leads 23 and the second side 15b define a third gap S11. In other words, the third gap S11 is encompassed by the fourth and fifth modified connection leads 23 and the second side 15b. The fourth and sixth modified connection leads 23 and the third side 15c define a fourth gap S11. In other words, the fourth gap S11 is encompassed by the fourth and sixth modified connection leads 23 and the third side 15c.

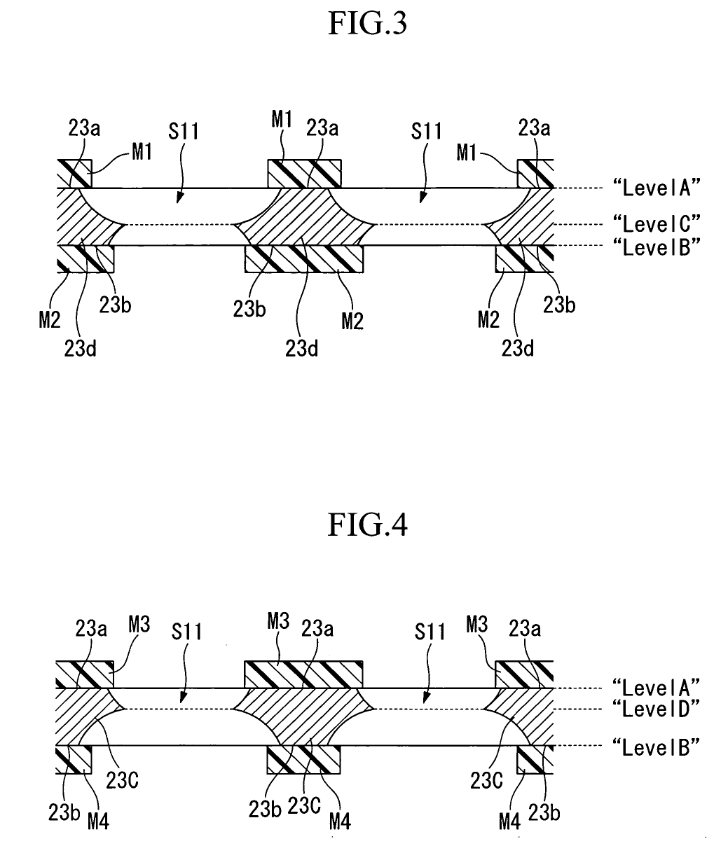

FIG. 3 is a fragmentary cross sectional elevation view illustrating a cross sectional shape of extension portions of the modified connection leads 23 that has been formed through a lithography process. FIG. 4 is a fragmentary cross sectional elevation view illustrating a cross sectional shape of base portions of the modified connection leads 23 that have been formed through the lithography process. Each of the modified connection leads 23 has a first surface 23a and a second surface 23b that opposes the first surface 23a. The first surface 23a communicates with the first surface 7a or 9a of the stage 7 or 9 on which the sensor chip 3 or 5 is mounted. Namely, the first surface 23a faces the same direction as the first surface 7a or 9a of the stage 7 or 9. Each of the modified connection leads 23 comprises a base portion 23c and an extension portion 23d.

The base portion 23c is adjacent to the square frame portion 15. The extension portion 23d extends from the base portion 23c to the flexible portion 25. The base portion 23c is different in cross sectional shape from the extension portion 23d. The extension portion 23d and the base portion 23c are bounded with each other by a virtual broken line that defines a periphery of a resin mold 29 in FIG. 1.

The extension portion 23d of the modified connection lead 23 has a cross sectional shape as shown in FIG. 3. The width of the extension portion 23d varies in a direction of thickness of the modified connection lead 23. The extension portion 23d has three different levels “A”, “B” and “C” in the thickness direction. The level “A” is leveled to the first surface 23a. The level “B” is leveled to the second surface 23b opposing to the first surface 23a. The level “C” is intermediate between the levels “A” and “B”, provided that the level “C” is closer to the level “B” than the level “A”. The extension portion 23d of the modified connection lead 23 has a maximum width at the level “C” and a minimum width at the level “A”. At the level “B”, the extension portion 23d has a width that is narrower than the maximum width and wider than the minimum width, provided that a difference in width between the levels “B” and “C” is smaller than another difference in width between the levels “B” and “A”. The width of the extension portion 23d of the modified connection lead 23 increases as the position moves from the level “A” to the level “C” in the direction of thickness and further decreases as the position moves from the level “C” to the level “B” in the direction of thickness.

The extension portion 23d of the modified connection lead 23 comprises a majority portion that is defined between the levels “A” and “C” and a minority portion that is defined between the levels “C” and “B”. The majority portion increases in width as the position moves from the level “A” to the level “C” in the direction of thickness. The minority portion decreases in with as the position moves from the level “C” to the level “B” in the direction of thickness. The majority portion has sloped side walls, while the minority portion has inversely sloped side walls that are smaller than the sloped side walls of the majority portion. The shape in cross section of the extension portion 23d of the modified connection lead 23 may be, but is not limited to, a modified connection trapezoid.

As shown in FIG. 3, each of the first to fourth gaps S11 is partially defined by the sloped side walls and the inversely sloped side walls of the extension portions 23d of the two adjacent modified connection leads 23. The width of each of the first to fourth gaps S11 that are defined by the extension portions 23d varies in the direction of thickness. Namely, the width of each of the first to fourth gaps S11 decreases as the position moves from the level “A” to the level “C” in the direction of thickness and increases as the position moves from the level “C” to the level “B” in the direction of thickness.

Each of the first to fourth gaps S11 has an area in plan view wherein the area varies depending on the level in the direction of thickness. The area is defined by the broken line shown in FIG. 1 and the extension portions 23d of two adjacent modified connection leads 23. Namely, the area in plan view of each of the first to fourth gaps S11 decreases as the position moves from the level “A” to the level “C” in the direction of thickness and increases as the position moves from the level “C” to the level “B” in the direction of thickness. Each of the first to fourth gaps S11 has a first area in plan view at the level “A”, a second area in plan view at the level “B” and a third area in plan view at the level “C”. Each of the first to third areas is defined by the broken line shown in FIG. 1 and the extension portions 23d of two adjacent modified connection leads 23. The first area is the largest one and the third area is smallest one. The second area is smaller than the first area and larger than the second area.

The modified connection shape in cross section of the extension portion 23d of the modified connection lead 23 can be obtained through photolithography and subsequent etching processes. In the photolithography process, first and second masks M1 and M2 are used. The first mask M1 is placed on a first surface of the square frame, while the second mask M2 is placed on a second surface of the square frame, which is opposite to the first surface. The square frame may comprise a metal plate. The first and second masks M1 and M2 comprise a line-space pattern. The first mask M1 has a narrower line width than that of the second mask M2. The first mask M1 has a wider space width than that of the second mask M2. The first mask M1 has the same line-and-space pitch as the second mask M2. The first and second surfaces of the square frame are subjected to an etching process using the first and second masks M1 and M2 so as to shape the extension portions 23d of the modified connection leads 23.

The base portion 23c of the modified connection lead 23 has a cross sectional shape as shown in FIG. 4. The width of the base portion 23c varies in the direction of thickness of the modified connection lead 23. The base portion 23c has three different levels “A”, “B” and “D” in the thickness direction. The level “A” is leveled to the first surface 23a. The level “B” is leveled to the second surface 23b opposing to the first surface 23a. The level “D” is intermediate between the levels “A” and “B”, provided that the level “D” is closer to the level “A” than the level “B”. The base portion 23c of the modified connection lead 23 has a maximum width at the level “D” and a minimum width at the level “B”. At the level “A”, the base portion 23c has a width that is narrower than the maximum width and wider than the minimum width, provided that a difference in width between the levels “A” and “D” is smaller than another difference in width between the levels “A” and “B”. The width of the base portion 23c of the modified connection lead 23 increases as the position moves from the level “A” to the level “D” in the direction of thickness and further decreases as the position moves from the level “D” to the level “B” in the direction of thickness.

The base portion 23c of the modified connection lead 23 comprises a majority portion that is defined between the levels “B” and “D” and a minority portion that is defined between the levels “D” and “A”. The majority portion decreases in width as the position moves from the level “D” to the level “B” in the direction of thickness. The minority portion increases in with as the position moves from the level “A” to the level “D” in the direction of thickness. The majority portion has inversely sloped side walls, while the minority portion has sloped side walls that are smaller than the inversely sloped side walls of the majority portion. The shape in cross section of the base portion 23c of the modified connection lead 23 may be, but not limited to, a modified connection inverted-trapezoid.

As shown in FIG. 4, each of the first to fourth gaps S11 is partially defined by the sloped side walls and the inversely sloped side walls of the base portions 23c of the two adjacent modified connection leads 23. The width of each of the first to fourth gaps S11 that are defined by the base portions 23c varies in the direction of thickness. Namely, the width of each of the first to fourth gaps S11 increases as the position moves from the level “A” to the level “D” in the direction of thickness and decreases as the position moves from the level “D” to the level “B” in the direction of thickness.

Each of the first to fourth gaps S11 has an area in plan view wherein the area varies depending on the level in the direction of thickness. The area is defined by the broken line shown in FIG. 1, the base portions 23c of two adjacent modified connection leads 23 and the square frame portion 15. Namely, the area in plan view of each of the first to fourth gaps S11 decreases as the position moves from the level “A” to the level “D” in the direction of thickness and increases as the position moves from the level “D” to the level “B” in the direction of thickness. Each of the first to fourth gaps S11 has a fourth area in plan view at the level “A”, a fifth area in plan view at the level “B” and a sixth area in plan view at the level “D”. Each of the fourth to sixth areas is defined by the broken line shown in FIG. 1, the base portions 23c of two adjacent modified connection leads 23 and the square frame portion 15. The fifth area is the largest one and the sixth area is smallest one. The fourth area is smaller than the fifth area and larger than the sixth area.

The modified connection shape in cross section of the base portion 23c of the modified connection lead 23 can be obtained through photolithography and subsequent etching processes. In the photolithography process, third and fourth masks M3 and M4 are used. The third mask M3 is placed on the first surface of the square frame, while the fourth mask M4 is placed on the second surface of the square frame, which is opposite to the first surface. The square frame may comprise the metal plate. The third and fourth masks M3 and M4 comprise a line-space pattern. The third mask M3 has a wider line width than that of the fourth mask M4. The third mask M3 has a narrower space width than that of the fourth mask M4. The third mask M3 has the same line-and-space pitch as the fourth mask M4. The first and second surfaces of the square frame are subjected to an etching process using the third and fourth masks M3 and M4 so as to shape the base portions 23c of the modified connection leads 23.

Preferably, the leads 17 may also have the same shape in cross section as the modified connection leads 23 because the leads 17 may be formed in the same process of forming the modified connection leads 23.

The modified connection leads 23 have the first surfaces 23a which communicate with the surfaces 7a and 9a of the stages 7 and 9 so that the first surfaces 23a and the surfaces 7a and 9a form a surface.

As shown in FIG. 1, each of the connections 13 comprises the flexible portion 25 and the modified connection leads 23. The flexible portion 25 extends adjacent to the side 7d or 9d of the stage 7 or 9. The modified connection leads 23 connect the flexible portion 25 to the square frame portion 15. The flexible portion 25 has a reference axial line L3 that is parallel to the side 7d or 9d of the stages 7 or 9 and that is perpendicular to the first diagonal line L1. Since the first diagonal line L1 is perpendicular to the second diagonal line L2, the reference axial line L3 is parallel to the second diagonal line L2. The flexible portion 25 is configured to be bent on the reference axial line L3. Namely, the flexible portion 25 has a width W1 that is narrower than the width of the stage 7 or 9. In order words, the flexible portion 25 has recessed side portions that define the narrow width W1. The flexible portion 25 has a thickness “t”. Preferably, the width W1 of the flexible portion 25 satisfies the conditions given by 0.5×t≦W1≦3.0×t. When the width W1 is larger than 3.0×t, the mechanical flexibility of the flexible portion 25 is low and might not allow the flexible portion 25 to be bent well on the reference axial line L3. When the width W1 is smaller than 0.5×t, the mechanical strength of the flexible portion 25 is low and might cause a disconnection at the flexible portion 25 between the modified connection leads 23 and the stage 7 or 9 when bending the flexible portion 25 at the reference axial line L3. More preferably, the width W1 of the flexible portion 25 satisfies the conditions given by 1.0×t≦W1≦3.0×t. When the width W1 is smaller than 1.0×t, the mechanical strength of the flexible portion 25 is low and might allow the flexible portion 25 to be twisted with reference to the modified connection leads 23.

A method of forming a magnetic sensor using the above-described lead frame I of FIG. 1 will be described. In the first step, the lead frame 1 described above with reference to FIGS. 1 and 2 is prepared. In the second step, the magnetic sensor chips 3 and 5 are bonded to the first surfaces 7a and 9a of the stages 7 and 9, respectively. In the third step, the leads 17 of the lead frame 1 are electrically connected through wirings to bonding pads that are provided on each of the magnetic sensor chips 3 and 5. The bonding pads are not illustrated in the drawings. The wirings can advantageously be flexible so as to allow the stages 7 and 9 to be sloped down or declined in a later process of bending the flexible portions 23 of the connections 13, thereby changing relative positions of the bonding pads of the magnetic sensor chips 3 and 5 with reference to the leads 17.

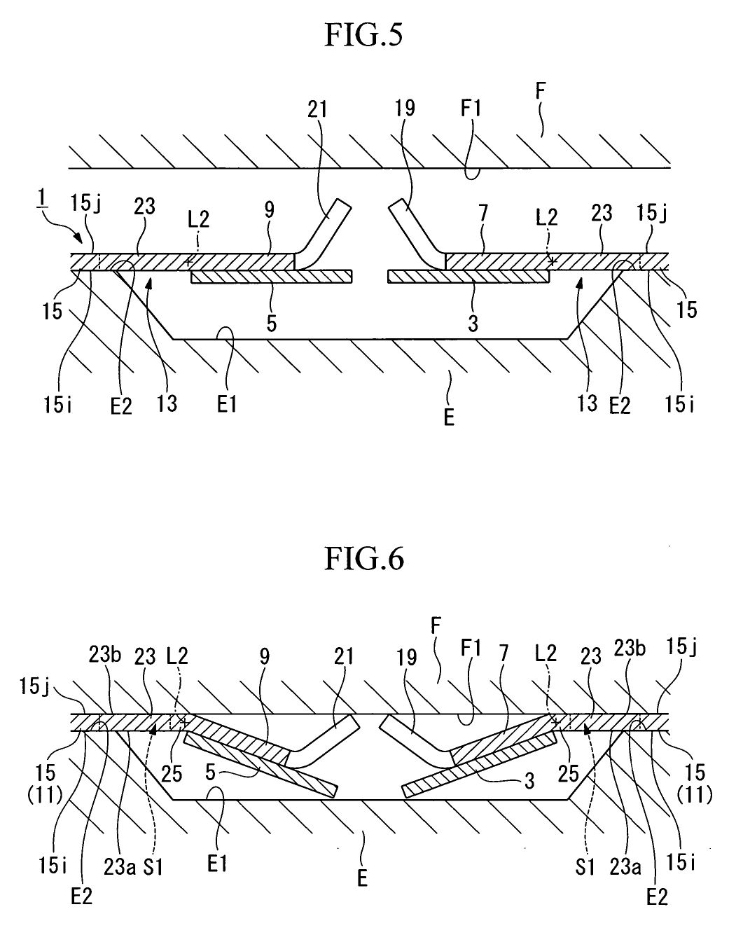

FIG. 5 is a fragmentary cross sectional elevation view illustrating the lead frame 1 in a step involved in a method of forming the magnetic sensor by using the lead frame 1 of FIG. 1 in accordance with the first embodiment of the present invention. FIG. 6 is a fragmentary cross sectional elevation view illustrating the lead frame 1 in another step involved in the method of forming the magnetic sensor by using the lead frame 1 of FIG. 1 in accordance with the first embodiment of the present invention.

With reference to FIG. 5, first and second dies “E” and “F” are prepared. The first die “E” has a concave “E1” and a peripheral ridge “E2”. The second die “F” has a flat surface “F1”. The concave “E1” and the flat surface “F1” define a cavity of the dies “E” and “F”. The lead frame 1 is placed on the first die “E”, wherein the square frame portion 15 is in contact with the peripheral ridge “E2”. The leads 17, the magnetic sensor chips 3 and 5, the stages 7 and 9, the connections 13 and the projecting parts 19 and 21 are positioned over the concave “E1” of the first die “E”. When the lead frame 1 is placed on the first die “E”, the magnetic sensor chips 3 and 5 are positioned under the stages 7 and 9, and the projecting parts 19 and 21 extend upwardly from the second surfaces 7c and 9c of the stages 7 and 9, respectively. The magnetic sensor chips 3 and 5 are distanced by a gap from the concave “E1” of the first die “E”. The projecting parts 19 and 21 are also distanced by another gap from the flat surface “F1”.

With reference to FIG. 6, the second die “F” moves toward the first die “E”, so that the flat surface “F1” presses down the projecting parts 19 and 21 until the first and second dies “E” and “F” sandwich the square frame portion 15 of the lead frame 1, whereby the flexible portions 25 are bent on the reference axial lines L3, and the stages 7 and 9 are sloped down or declined from the above-described plane that includes the first and second diagonal lines L1 and L2. Since the square frame portion 15 extends two-dimensionally in the plane that includes the first and second diagonal lines L1 and L2, the plane also includes the square frame portion 15. The magnetic sensor chips 3 and 5 which are respectively mounted on the stages 7 and 9 are also sloped down or declined together with the stages 7 and 9. The sloped magnetic sensor chips 3 and 5 have a predetermined slope angle with reference to the square frame portion 15 and to the flat surface “F1”. The predetermined slope angle is determined by the projecting parts 19 and 21. For example, the predetermined slope angle is determined by a distance between the reference axial line L3 and each of the projecting parts 19 and 21 and by a dimension or size of each of the projecting parts 19 and 21, wherein the dimension is defined in a direction vertical to the plane that includes each of the projecting parts 19 and 21. When the first and second dies “E” and “F” sandwich the square frame portion 15, the first surface 1Si of the square frame portion 15 is in contact with the peripheral ridge “E2” of the first die “E”, while the second surface 15j of the square frame portion 15 is in contact with the flat surface “F1”.

A molten resin is injected into the cavity of the dies “E” and “F” while using the second die “F” to hold down the projecting parts 19 and 21, whereby the magnetic sensor chips 3 and 5 and the stages 7 and 9 are molded and sealed with the resin. As described above, the cavity is defined by the concave “E1” of the first die “E” and the flat surface “F1” of the second die “F”.

In the injection-molding process, the molten resin is injected into the cavity through a gate “G” shown in FIG. 1. The gate “G” is positioned on the second diagonal line L2 and at the fourth corner 15h of the square frame portion 15 of the lead frame 1. In the cavity, the molten resin when injected will flow with a spread toward the first, second and third corners 15e, 15f and 15g and the first and second sides 15a and 15b. This flow of the molten resin will include a primary stream toward the second corner 15f opposing to the gate “G” and secondary streams toward the first and second sides 15a and 15b and the first and third corners 15e and 15g. The secondary streams are caused by the spread from the primary stream. The primary stream of the molten resin will run along the second diagonal line L2. As described above, the reference axial line L3 is parallel to the second diagonal line L2. Thus, the primary stream that runs along the second diagonal line L2 will be directed in parallel to the reference axial lines L3. The first and second surfaces 7a and 7c of the sloped or declined stage 7 are parallel to the second diagonal line L2. The first and second surfaces 9a and 9c of the sloped or declined stage 9 are also parallel to the second diagonal line L2. The sloped or declined magnetic sensor chips 3 and 5 which are respectively mounted on the sloped or declined stages 7 and 9 are also parallel to the second diagonal line L2. Accordingly, the primary stream of the molten resin will be directed in parallel to the sloped or declined stages 7 and 9 and to the sloped or declined magnetic sensor chips 3 and 5. This means that the primary stream of the molten resin can not be disturbed substantially by the presence of the sloped stages 7 and 9 and the sloped magnetic sensor chips 3 and 5. Further, the primary stream of the molten resin can not push substantially the sloped stages 7 and 9 and the sloped magnetic sensor chips 3 and 5.

As shown in FIGS. 1, 3 and 6, in the injection molding process, the primary stream of the molten resin reaches the second corner 15f, while the secondary streams of the molten resin reach the first and second corners 15e and 15g so that the first to fourth gaps S11 are filled up with the molten resin. The molten resin of the secondary stream flows along the first surfaces 23a of the modified connection leads 23 and then flows into the first to fourth gaps S11. As described above, the extension portions 23d of the modified connection leads 23 have the modified connection trapezoidal shape. The extension portion 23d comprises the majority portion and the minority portion. The majority portion provides the first surface 23a and the sloped side walls, while the minority portion provides the second surface 23b and the inversely sloped side walls. The width of the majority portion of the extension portion 23d increases as the position moves from the level “A” to the level “C”. The level “A” is leveled to the first surface 23a. The level “C” is the deep level from the level “A”. The above-described first area of each of the first to fourth gaps S11 at the level “A” is larger than the above-described third area of each of the first to fourth gaps S11 at the level “C”. The molten resin flows along the above-described sloped side walls of the extension portions 23d of the modified connection leads 23 and fills up each of the first to fourth gaps S11. The above-described sloped side walls of the extension portions 23d permit the molten resin to flow into and to fill up each of the first to fourth gaps S11. In other words, the above-described modified connection trapezoidal shape in cross section of the extension portion 23d of the modified connection lead 23 ensures that the molten resin flows into and fills up each of the first to fourth gaps S11 without forming any voids in the resin mold 29.

The sloped stages 7 and 9 with the sloped magnetic sensor chips 3 and 5 extend in parallel to the first diagonal line L1 along which the primary stream of the molten resin runs in the injection molding process. Further, the sloped stages 7 and 9 with the sloped magnetic sensor chips 3 and 5 are distanced from the first diagonal line L1. Thus, the sloped stages 7 and 9 with the sloped magnetic sensor chips 3 and 5 are not exposed to the primary stream but may be exposed to the secondary streams. Preferably, the resin has a high fluidity in order to prevent the flow of the molten resin when injected in the cavity from changing the slope angle of the sloped stages 7 and 9 and the sloped magnetic sensor chips 3 and 5.

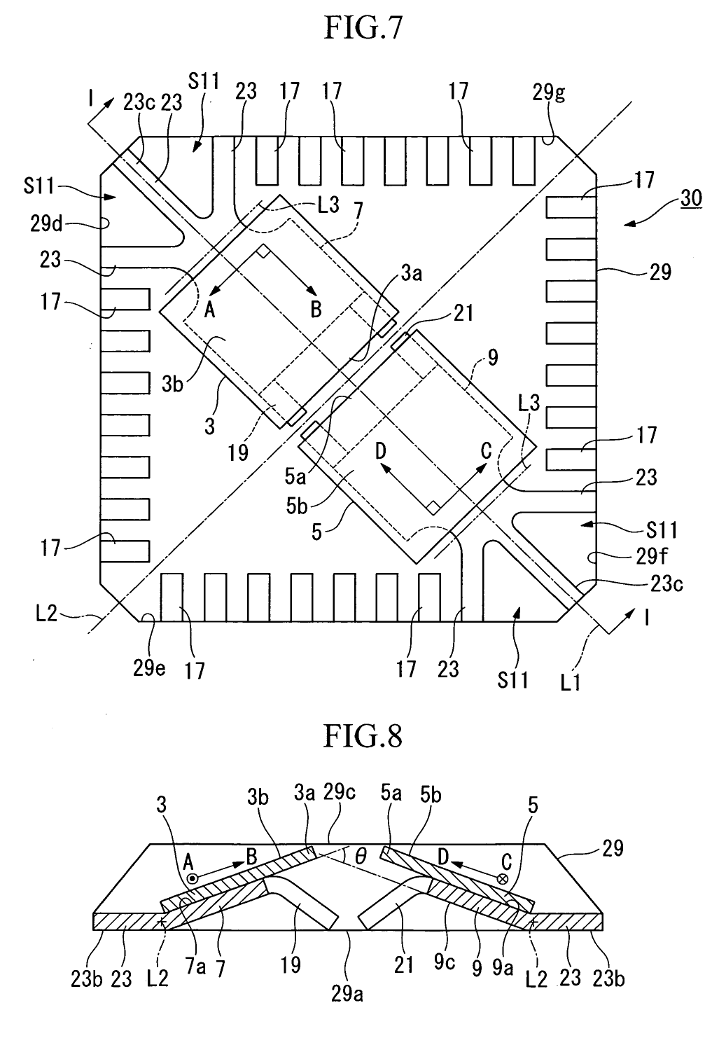

FIG. 7 is a plan view illustrating a magnetic sensor formed by using the lead frame 1 of FIG. 1. FIG. 8 is a cross sectional elevation view taken along an I-I line of FIG 5 illustrating the magnetic sensor. In the above-described process of molding the lead frame 1, the sloped magnetic sensor chips 3 and 5 on the sloped stages 7 and 9 are sealed with the molten resin when injected into the cavity. The molten resin is then cooled and solidified to form a resin mold 29. As shown in FIGS. 7 and 8, through the molding process, the sloped magnetic sensor chips 3 and 5 on the sloped stages 7 and 9 are encapsulated and sealed with the resin mold 29. The sloped magnetic sensor chips 3 and 5, the leads 17 and the extension portions 23d of the modified connection leads 23 are fixed in the resin mold 29, while the square frame portion 15 and the base portions 23c of the modified connection leads 23 extend outside the resin mold 29.

The square frame portion 15 outside the resin mold 29 is then cut off and removed from the resin mold 29. The outside portions of the leads 17 and the base portions 23c of the modified connection leads 23 are detruncated and removed from the resin mold 29, thereby completing a magnetic sensor 30.

The magnetic sensor 30 includes the sloped magnetic sensor chips 3 and 5, the sloped stages 7 and 9, the projecting parts 19 and 21, remaining portions of the leads 17, the extension portions 23d of the modified connection leads 23, and the resin mold 29. The resin mold 29 has a generally square shape in plan view. The resin mold 29 further has a flat bottom surface 29a and a flat top surface 29c. The second surfaces 23b of the modified connection leads 23 and the reverse surfaces of the leads 17 are leveled to and shown in the flat bottom surface 29a. The projecting parts 19 and 21 have tops that are leveled to and shown in the flat bottom surface 29a. The leads 17 are connected to the sloped magnetic sensor chips 3 and 5 through wirings that are not illustrated. The wirings are also sealed and encapsulated by the resin mold 29.

The sloped magnetic sensor chips 3 and 5 are buried in the resin mold 29, wherein the sloped magnetic sensor chips 3 and 5 tilt from the flat bottom surface 29a of the resin mold 29. The sloped magnetic sensor chips 3 and 5 are included in two sloped planes that cross each other at an acute angle θ. Namely, the sloped magnetic sensor chips 3 and 5 have sloped angles that are different from each other by the acute angle θ. This acute angle θ is shown in FIG. 8 and is different from the above-described slope angle. Since the magnetic sensor chips 3 and 5 are respectively mounted on the sloped stages 7 and 9, the sloped angles 7 and 9 are also included in two sloped planes that cross each other at the acute angle θ. Namely, the sloped stages 7 and 9 have sloped angles that are different from each other by the acute angle θ.

Each of the sloped magnetic sensor chips 3 and 5 is configured to sense two components of an external magnetic field that is applied to the magnetic sensor 30. The directions of the two components are perpendicular to each other but both are parallel to the sloped plane including the sloped magnetic sensor chip 3 or 5. For example, in FIG. 8, the sloped magnetic sensor chip 3 senses a first component of the external magnetic field in a first direction marked by an arrow “A” and a second component of the external magnetic field in a second direction marked by an arrow “B”. The first and second directions “A” and “B” are perpendicular to each other but both are parallel to the first sloped plane including the sloped magnetic sensor chip 3. The sloped magnetic sensor chip 5 senses a third component of the external magnetic field in a third direction marked by an arrow “C” and a fourth component of the external magnetic field in a fourth direction marked by an arrow “D”. The third and fourth directions “C” and “D” are perpendicular to each other but both are parallel to the second sloped plane including the sloped magnetic sensor chip 5. The first and third directions “A” and “C” are anti-parallel to each other and both are perpendicular to the first diagonal line L1 and parallel to the second diagonal line L2. The second and fourth directions “B” and “D” are different from each other by the acute angle θ and both are perpendicular to the second diagonal line L2.

The first sloped plane that is parallel to the first and second directions “A” and “B” and the second sloped plane that is parallel to the first and second directions “C” and “D” cross each other at the above-described acute angle θ. This acute angle θ may theoretically be greater than 0 degree and at most 90 degrees, to enable the magnetic sensor 30 to sense accurately the azimuth of three-dimensional geomagnetism. The acute angle θ is preferably in the range of 20 degrees to 90 degrees, and more preferably in the range of 30 degrees to 90 degrees.

The magnetic sensor 30 may advantageously be integrated or mounted on a circuit board that is included in a device such as a mobile terminal. A typical example of the mobile terminal may include, but is not limited to, a cellular phone. When the magnetic sensor 30 is integrated in the cellular phone, it is advantageously possible for the magnetic sensor 30 to sense the azimuth of geomagnetism and display it on a display panel of the cellular phone.

The surfaces of the leads 17 and the second surfaces of the modified connection leads 23 are exposed from the flat surface 29a of the resin mold 29. The exposed surfaces of the leads 17 and the exposed surfaces of the modified connection leads 23 are bonded through solders to a substrate or a board in order to mount the magnetic sensor 30 onto the substrate. When the magnetic sensor 30 receives an external force that acts to separate the magnetic sensor 30 from the substrate, the leads 17 and the modified connection leads 23 also receive another force that acts to separate the same from the substrate. As described above, however, each of the leads 17 and the modified connection leads 23 has the modified connection trapezoidal shape with the sloped side walls and the exposed surface. The sloped side walls engage with the resin mold 29 so as to prevent the leads 17 and the modified connection leads 23 from being separated from the resin mold 29 upon receipt of the applied external force.

As described above, the molten resin of the secondary stream flows along the first surfaces 23a of the modified connection leads 23 and then flows into the first to fourth gaps S11. The extension portions 23d of the modified connection leads 23 have the modified connection trapezoidal shape. The width of the majority portion of the extension portion 23d increases as the position moves from the level “A” to the level “C”. The above-described first area of each of the first to fourth gaps S11 at the level “A” is larger than the above-described third area of each of the first to fourth gaps S11 at the level “C”. The molten resin flows along the above-described sloped side walls of the extension portions 23d of the modified connection leads 23 and fills up each of the first to fourth gaps S11. The above-described sloped side walls of the extension portions 23d permit the molten resin to flow into and to fill up each of the first to fourth gaps S11. In other words, the above-described modified connection trapezoidal shape in cross section of the extension portion 23d of the modified connection lead 23 ensures that the molten resin flows into and fills up each of the first to fourth gaps S11 without forming any voids in the resin mold 29. This allows a further reduction in dimension or size of the magnetic sensor 30.

As described above, it is preferable for the width W1 of the flexible portion 25 to satisfy the conditions given by 0.5×t≦W1≦3.0×t. This ensures that the flexible portion 25 has the desired high flexibility and mechanical strength for allowing the flexible portion to be bent well on the reference axial line L3, thereby tilting the stage 7 or 9 without causing a disconnection at the flexible portion 25 between the modified connection leads 23 and the stage 7 or 9. It is more preferable for the width W1 of the flexible portion 25 to satisfy the conditions given by 1.0×t≦W1≦3.0×t. This further ensures that the flexible portion 25 be bent without causing any twisting with reference to the modified connection leads 23.

The sloped stages 7 and 9 with the sloped magnetic sensor chips 3 and 5 are distanced from the second diagonal line L2 along which the primary stream of the molten resin runs in the injection molding process so that the primary stream of the molten resin can not be disturbed substantially by the stages 7 and 9, whereby the molten resin reaches the second corner 15f that opposes the fourth corner 15h at which the gate “G” is positioned.

Further, the sloped stages 7 and 9 and the sloped magnetic sensor chips 3 and 5 are distanced from the second diagonal line L2 along which the primary stream of the molten resin when injected runs in the above-described injection molding process. Thus, the primary stream of the molten resin when injected in the cavity can not push substantially the sloped stages 7 and 9 and the sloped magnetic sensor chips 3 and 5, thereby causing substantially no changes to the slope angles of the magnetic sensor chips 3 and 5. Substantially no changes to the slope angles of the magnetic sensor chips 3 and 5 cause substantially no change to the above-described acute angle θ defined between the sloped magnetic sensor chips 3 and 5.

The flexible portion 25 has the width “W1” which is narrower than the stage 7 but wider than the first to third modified connection leads 23. The flexible portion 25 may have, but does not have to have, the same thickness as the stage 7 and the projecting portions 19. The first to third modified connection leads 23 may also have, but do not have to have, the same thickness as the flexible portion 25. Alternatively, the flexible portion 25 may be, but does not have to be, thinner than the stages 7 and 9 and the modified connection leads 23. The reduction in thickness of the flexible portion 25 increases the flexibility thereof and reduces the mechanical strength thereof. The reduction in thickness of the flexible portion 25 may be obtained by half-etching the flexible portion 25. When the flexible portion 25 has the reduced-thickness, the width “W1” is preferably decided with reference to the reduced-thickness so as to satisfy the above-described conditions given by 0.5×t≦W1≦3.0×t.

### Second Embodiment

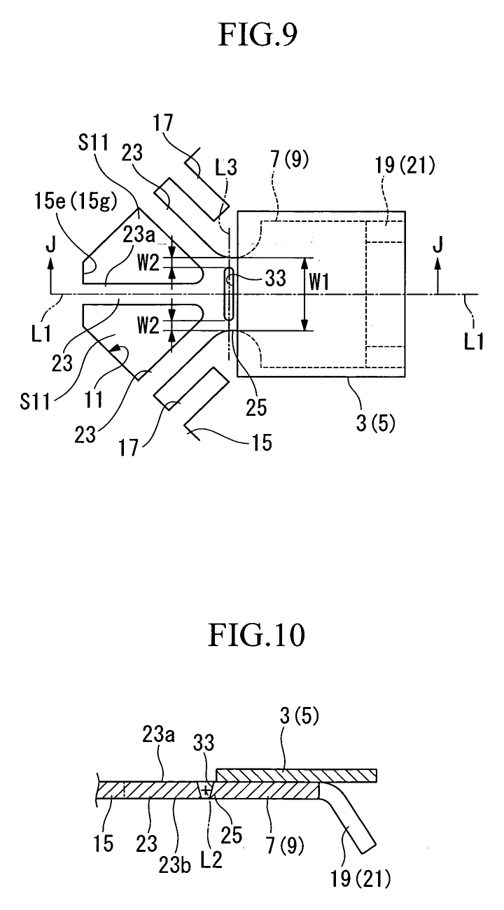

A second embodiment of the present invention will be described. The following descriptions will be directed to differences of the second embodiment from the above-described first embodiment. FIG. 9 is a fragmentary plan view illustrating a lead frame including modified connection leads with modified connection flexible portions in accordance with a second preferred embodiment of the present invention. FIG. 10 is a fragmentary cross sectional view of the lead frame, taken along a J-J line of FIG. 9.

The lead frame shown in FIGS. 9 and 10 is different from the above-described lead frame shown in FIGS. 1 and 2 only in the flexible portion. The following descriptions will be directed to the difference of the lead frame between the first and second embodiments. The flexible portion 25 extends adjacent to the stage 7 or 9. The modified connection leads 23 extend from the flexible portion 25 to the square frame portion 15. The flexible portion 25 has a single slit 33 comprising a long narrow opening that penetrates the flexible portion 25 in the direction of thickness of the flexible portion 25. The slit 33 has opposite ends that are rounded in plan view. The slit 33 extends along the reference axial line L3. The slit 33 has a lengthwise direction that is parallel to the second diagonal line L2 and is perpendicular to the first diagonal line L2. The slit 33 extends symmetrically with reference to the reflection-symmetric axis that comprises the first diagonal line L1. The flexible portion 25 has a dimension “W1” that is defined as a distance between both sides of the flexible portion 25 on the reference axial line L3.

The flexible portion 25 has two narrow portions that are separated from each other by the slit 33. Each of the two narrow portions is defined by between the side of the flexible portion 25 and the end of the slit 33. Each of the two narrow portions has a width “W2” that is defined as a dimension of the narrow portion on the reference axial line L3. The length of the slit 33 is given by a subtraction of 2×W2 from the dimension “W1”. The dimension “W1” corresponds to an apparent width of the flexible portion 25. The flexible portion 25 has an effective width “Weffect=2×W2” that is given by the sum of the width “W2” of the two narrow portions. The flexibility and the mechanical strength of the flexible portion 25 depend on the thickness and the effective width of the flexible portion 25. The term “effective width” means a width that is given by a subtraction of a total length of one or more slits on the reference axial line L3 from the dimension “W1” that is defined as a distance between both sides of the flexible portion 25 on the reference axial line L3. The flexible portion 25 on the reference axial line L3 has a thickness “t”.

Preferably, the effective width “Weffect=2×W2” of the flexible portion 25 on the reference axial line L3 satisfies the conditions given by 0.5×t≦“Weffect=2×W2” ≦2.0×t. When the effective width “Weffect=2×W2” is larger than 2.0×t, the mechanical flexibility of the flexible portion 25 is low and might not allow the flexible portion 25 to be bent well on the reference axial line L3. When the effective width “Weffect=2×W2” is smaller than 0.5×t, the mechanical strength of the flexible portion 25 is low and might cause a disconnection at the flexible portion 25 between the modified connection leads 23 and the stage 7 or 9 when bending the flexible portion 25 at the reference axial line L3. As described above, the effective width “Weffect=2×W2” of the flexible portion 25 of FIG. 9 is given by the subtraction of the length of the slit 33 from the dimension “W1” of the flexible portion 25.

Preferably, the length of the slit 33 is at least 0.5 mm, wherein the length of the slit 33 is defined as a dimension of the slit 33 along the reference axial line L3. Also, the width of the slit 33 is preferably at least 0.2 mm, wherein the width of the slit 33 is defined as another dimension of the slit 33 in a direction parallel to the first diagonal line L1.

As shown in FIG. 10, sloped inside walls of the flexible portion 25 define the slit 33. The slit 33 has a width that varies in the direction of thickness of the flexible portion 25. The width of the slit 33 is defined as a dimension of the slit 33 in a direction parallel to the first diagonal line L1. Namely, the width of the slit 33 decreases as the position moves from a first level of a first surface of the flexible portion 25 to a second level of a second surface that opposes the first surface. As described above, the flexible portion 25 may have the same thickness as or a smaller thickness than that of the modified connection leads 23 and the stages 7 and 9. When the flexible portion 25 has the same thickness as that of the modified connection leads 23, the first and second levels of the first surfaces correspond respectively to the levels “A” and “B” shown in FIG. 3. The flexible portion 25 also has a third level that corresponds to the level “C” shown in FIG. 3. The slit 33 has a maximum width at the first level that corresponds to the level “A”. The slit 33 has a minimum width at the third level that corresponds to the level “C”. The slit 33 has an intermediate width at the second level that corresponds to the level “B”. The flexible portion 25 has a sloped side wall that extends between the first and third levels and an inversely sloped side wall that extends between the third and second levels. Both the sloped side wall and the inversely sloped side walls define the shape of the slit 33 in plan view. The flexible portion 25 has a majority portion that has the sloped side wall extending between the first and third levels and a minority portion that has the inversely sloped side wall extending between the third and second levels.

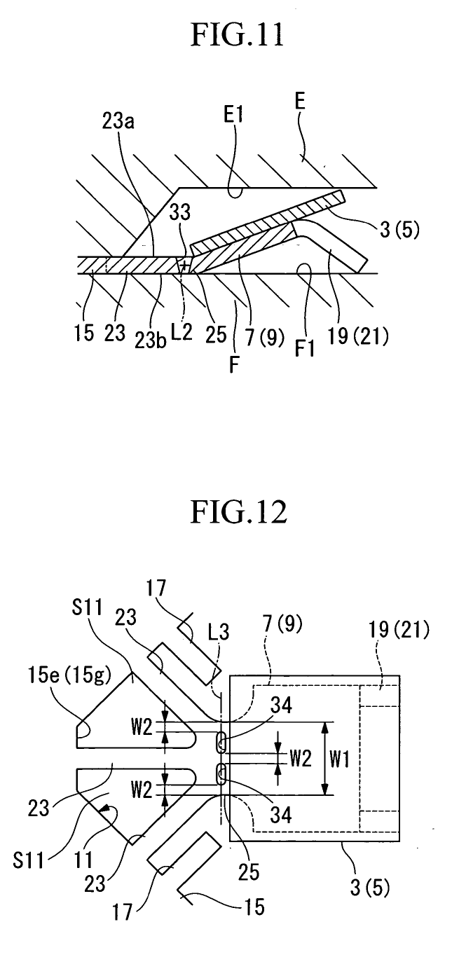

FIG. 11 is a fragmentary cross sectional elevation view illustrating the lead frame in a step involved in the method of forming the magnetic sensor by using the lead frame of FIG. 1 in accordance with the second embodiment of the present invention. The die “F” moves toward the counterpart die “E” and the flat surface “F1” of the die “F” pushes the projections 19 or 21, whereby the flexible portion 25 with the slit 33 is bent on the reference axial line L3 and the stage 7 or 9 with the magnetic sensor chip 3 or 5 is tilted. Bending the flexible portion 25 on the reference axial line L3 narrows the width of the slit 33 at the first level that is leveled to the first surfaces 23a of the modified connection leads 23 as shown in FIG. 11. Bending the flexible portion 25 on the reference axial line L3 deforms the shape in cross section of the slit 33 taken along the first diagonal line L1. The deformed shape is still trapezoidal. Namely, even after the flexible portion 25 has been bent, the slit 33 has the deformed trapezoidal shape, and the width of the slit 33 at the first level still remains larger than the width thereof at the second level that is leveled to the second surface 23b. After the flexible portion 25 has been bent, the flexible portion 25 still retains the sloped side walls. The sloped side walls permit the secondary stream of the molten resin to flow into and to fill up the slit 33 of the flexible portion 25 in the injection molding process.

The molten resin flows along the sloped side walls of the majority portion of the flexible portion 25 and fills up each of the slits 33. The sloped side walls of the majority portion of the flexible portion 25 permit the molten resin to flow into and to fill up the slit 33 without forming any voids in the resin mold 29. The cross-sectional shape of the slit 33 may be obtained by the same technique as used for forming the modified connection leads 23. For example, the photo-lithography process can be performed using two masks that are different in space width from each other. A first one of the masks has a wider space than that of a second one of the masks. The first and second masks are placed on the first and second surfaces of the flexible portion 25, respectively. An etching process is then performed using the first and second masks to form the above-described slit 33.

The lead frame 1 with the flexible portion 25 of this second embodiment provides substantially the same effects and advantages as those of the first embodiment.

The provision of the slit 33 of the flexible portion 25 increases the mechanical flexibility of the flexible portion 25 on the reference axial line L3, thereby making it easy to bend the flexible portion 25 on the reference axial line L3 and to tilt the stages 7 and 9 accurately so that the stages 7 and 9 have predetermined slope angles. As described above, the slit 33 is preferably configured so that the effective width “Weffect=2×W2” of the flexible portion 25 on the reference axial line L3 satisfies the conditions given by 0.5×t≦“Weffect=2×W2”≦2.0×t. This ensures that the flexible portion 25 has the desired high flexibility and mechanical strength for allowing the flexible portion to be bent well on the reference axial line L3, thereby tilting the stage 7 or 9 without causing a disconnection at the flexible portion 25 between the modified connection leads 23 and the stage 7 or 9.

Not only the gaps S11 but also the slit 33 engage with the resin mold 29 whereby the lead frame 1 also engages with the resin mold 29. This contributes to securing or fixing the sloped stages 7 and 9 with the sloped magnetic sensor chips 3 and 5 to the resin mold 29.

In accordance with this second embodiment, each of the flexible portions 25 has the single slit 33. It is possible as a modification for the flexible portions 25 to have a plurality of slits 34 that are aligned on the reference axial line L3 and separated from each other. The number of the slits 34 should not be limited, but typically may be two. FIG. 12 is a fragmentary plan view illustrating a lead frame including modified connection leads with modified flexible portions in accordance with a first modification of the second preferred embodiment of the present invention. The flexible portion 25 has two slits 34 that are aligned on the reference axial line L3 and separated from each other. Each of the slits 34 comprises a long narrow opening that penetrates the flexible portion 25 in the direction of thickness of the flexible portion 25. Each of the two slits 34 have opposite ends that are rounded in plan view. Each of the slits 34 extends along the reference axial line L3. Each of the two slits 34 has a lengthwise direction that is parallel to the second diagonal line L2 and is perpendicular to the first diagonal line L2. The two slits 34 are positioned symmetrically to each other with reference to the reflection-symmetric axis that comprises the first diagonal line L1. The flexible portion 25 has the dimension “W1” that is defined as the distance between both sides of the flexible portion 25 on the reference axial line L3.

The flexible portion 25 has three narrow portions that are separated from each other by the two slits 34. A center one of the three narrow portions is defined by between the two slits 34. Each of the remaining two of the three narrow portions is defined by between the side of the flexible portion 25 and a proximal one of the two slits 34. Each of the three narrow portions has a width “W2” that is defined as a dimension of the narrow portion on the reference axial line L3. The sum of the length of the two slits 34 is given by a subtraction of 3 X W2 from the dimension “W1”. The dimension “W1” corresponds to the apparent width of the flexible portion 25. The flexible portion 25 has an effective width “Weffect=3×W2” that is given by the sum of the width “W2” of the three narrow portions. The flexibility and the mechanical strength of the flexible portion 25 depend on the thickness and the effective width of the flexible portion 25. The flexible portion 25 on the reference axial line L3 has a thickness “t”.

Preferably, the effective width “Weffect=3×W2” of the flexible portion 25 on the reference axial line L3 satisfies the conditions given by 0.5×t≦Weffect=3×W2≦2.0×t. When the effective width “Weffect=3×W2” is larger than 2.0×t, the mechanical flexibility of the flexible portion 25 is low and might not allow the flexible portion 25 to be bent well on the reference axial line L3. When the effective width “Weffect=3×W2” is smaller than 0.5×t, the mechanical strength of the flexible portion 25 is low and might cause a disconnection at the flexible portion 25 between the modified connection leads 23 and the stage 7 or 9 when bending the flexible portion 25 at the reference axial line L3. As described above, the effective width “Weffect=3×W2” of the flexible portion 25 of FIG. 12 is given by the subtraction of the sum of the length of the two slits 34 from the dimension “W1” of the flexible portion 25.

It is possible as a modification for the flexible portion 25 to have, instead of the slit 33 or the slits 34, one or more through holes that have an oval or circular shape in plan view. When the slit 33 or the slits 34 has a circular shape, the diameter of the slit 33 may preferably be in the range from 0.1 mm to 0.5 mm.

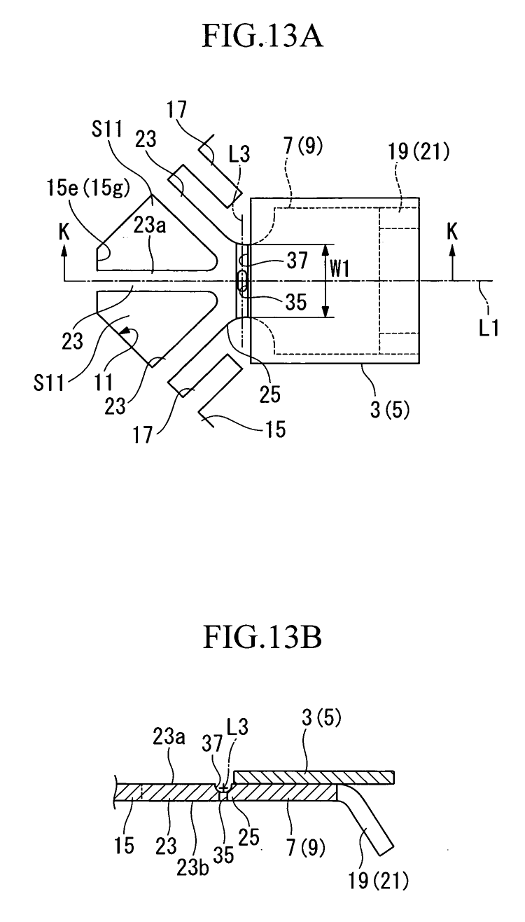

It is possible as a modification for the flexible portion 25 to have a thin portion and one or more through holes that are formed in the thin portion. The thin portion is thinner than the remaining portion of the flexible portion 25. The thin portion extends along the reference axial line L3. The one or more through holes are also positioned on the reference axial line L3. The combination of the thin portion with the one or more through holes increases the mechanical flexibility of the flexible portion 25. FIG. 13A is a fragmentary plan view illustrating a lead frame including modified connection leads with modified flexible portions in accordance with a second modification of the second preferred embodiment of the present invention. FIG. 13B is a fragmentary cross sectional elevation view, taken along a K-K line of FIG. 13A. The flexible portion 25 has a groove 37 providing a thin portion and a slit 35 providing a through hole. The groove 37 extends along the reference axial line L3 between the opposite sides of the flexible portion 25. The groove 37 has the same length as the width “W1” of the flexible portion 25. The slit 35 is formed in the groove 37. The slit 35 is positioned at a cross point of the reference axial line L3 and the first diagonal line L1. The slit 35 extends symmetrically with reference to both the reflection-symmetric axis of the reference axial line L3 and the other reflection-symmetric axis of the first diagonal line L1. The slit 35 has a length that is defined by a dimension on the reference axial line L3 and a width that is defined by another dimension on the first diagonal line L1. The length of the slit 35 is much smaller than the length of the groove 37. Preferably, the width of the slit 35 is smaller than the width of the groove 37 as shown in FIGS. 13A and 13B. The groove 37 may preferably have a bottom and sloped side walls that are adjacent to the bottom and separated from each other by the bottom. The slit 35 penetrates the thin portion under the groove 37. The slit 35 may have vertical side walls or sloped side walls. The sloped side walls of the groove 37 assists the flow of the molten resin when injected so that it fills up the slit 35.

In accordance with the first and second embodiments, the above-described modified trapezoidal shape in cross section of each of the leads 17 and the modified connection leads 23 is obtained by the photo-lithography technique. It is also possible as a modification for the above-described modified trapezoidal shape of each of the leads 17 and the modified connection leads 23 to be obtained by any available technique other than the photo-lithography technique.

In accordance with the first and second embodiments, the extension portion 23d of each of the modified connection leads 23 has the above-described modified trapezoidal shape, wherein the width of the extension portion 23d increases as the position moves from the level “A” to the level “C” in the direction of thickness. The modified connection leads 23 may have a modified trapezoidal shape such that the width of the extension portion 23d increases in the direction that is anti-parallel to the direction in which the stages 7 and 9 tilt from the plane that includes the modified connection leads 23 with reference to the reference axial line L3 of the flexible portion 25. Namely, the extension portion 23d of the modified connection lead 23 has the sloped side walls that permit the secondary stream of the molten resin to flow into and to fill up each of the first and fourth gaps S11. In other words, the extension portion 23d of the modified connection lead 23 has the sloped side walls that face toward the direction in which the stages 7 and 9 tilt from the plane that includes the modified connection leads 23 with reference to the reference axial line L3 of the flexible portion 25.

In accordance with the first and second embodiments, the stages 7 and 9 are advantageously positioned symmetrically to each other with reference to the reflection-symmetric axis of the second diagonal line L2 along which the primary stream of the molten resin will run in the injection molding process. It is possible as another typical example for the stages 7 and 9 to be connected to the first and second sides 15a and 15b that are adjacent to the second corner 15f toward which the primary stream of the molten resin flows from the gate “G” of the fourth corner 15h, regardless of whether the stages 7 and 9 are positioned symmetrically or asymmetrically to each other with reference to the reflection-symmetric axis of the second diagonal line L2. This configuration provides substantially the same effects and advantages as described above. It is also possible as still another typical example for the stages 7 and 9 to be connected to the first and third corners 15e and 15g that are distal from the second diagonal line L2 along which the primary stream of the molten resin will run, regardless of whether the stages 7 and 9 are positioned symmetrically or asymmetrically to each other with reference to the reflection-symmetric axis of the second diagonal line L2. This configuration provides substantially the same effects and advantages as described above.

In accordance with the first and second embodiments, the primary stream of the molten resin runs along the second diagonal line L2, and the stages 7 and 9 are distanced from the second diagonal line L2. It is possible as a modification for the stages 7 and 9 to be distanced from a primary stream line along which the primary stream of the molten resin will run in the injection molding process, so as to prevent the stages 7 and 9 from being exposed to the primary stream, regardless of whether the primary stream line is aligned to or displaced from the second diagonal line L2. It is advantageously possible for the stages 7 and 9 to be distanced from the primary stream line and to be positioned symmetrically to each other with reference to the reflection-symmetric axis of the primary stream line.

In accordance with the first and second embodiments, the projecting parts 19 and 21 extend from the peripheries or the ends of the stages 7 and 9. It is possible that the projecting parts 19 and 21 extend from the bottom surfaces of the stages 7 and 9, regardless of the exact positions from which the projecting parts 19 and 21 extend.

In accordance with the first and second embodiments, the projecting parts 19 and 21 are used to slope or decline the stages 7 and 9. Alternatively, none of the projecting parts 19 and 21 may be needed, provided that the stages 7 and 9 with the magnetic sensor chips 3 and 5 have already been sloped or declined by the known or available technique, prior to the injection-molding process of forming the resin mold 29.

In accordance with the first and second embodiments, each of the stages 7 and 9 has the square shape in plan view. It is possible for each of the stages 7 and 9 to have a modified shape that allows the magnetic sensor chips 3 and 5 to be mounted thereon. Typical examples of the shape in plan view of the stages 7 and 9 may include, but are not limited to, a square, a rectangle, a circle, and an oval. Other typical examples of the stages 7 and 9 may include, but are not limited to, a meshed stage and another stage that has one or more through holes which penetrate in the thickness-defining direction of the stage. The stages 7 and 9 may also be different in shape or size from each other.

In accordance with the first and second embodiments, the magnetic sensor chips 3 and 5, the stages 7 and 9 and the leads 17 are fixed to and encapsulated in the resin mold 29. It is possible as a modification to form a semiconductor package that contains and encapsulates the magnetic sensor chips 3 and 5, the stages 7 and 9 and the leads 17.

In accordance with the first and second embodiments, the lead frame 1 includes the square frame portion 15 that has a generally square shape. It is also possible to modify the shape in plan view of the frame portion. Typical examples of the shape in plan view of the frame portion may include, but are not limited to, a general square and a general rectangle.

In accordance with the first and second embodiments, the magnetic sensor for sensing the azimuth and the magnitude of geomagnetism is provided. It is possible as a modification of the above-described lead frame to mount another sensor for sensing at least the direction, the azimuth or the orientation of a physical quantity in the three-dimensional space. Typical examples of the physical quantity include magnetic field, acceleration and other vector quantities. It is possible for the lead frame 1 to mount an acceleration sensor chip that senses the direction and the magnitude of acceleration. Third Embodiment:

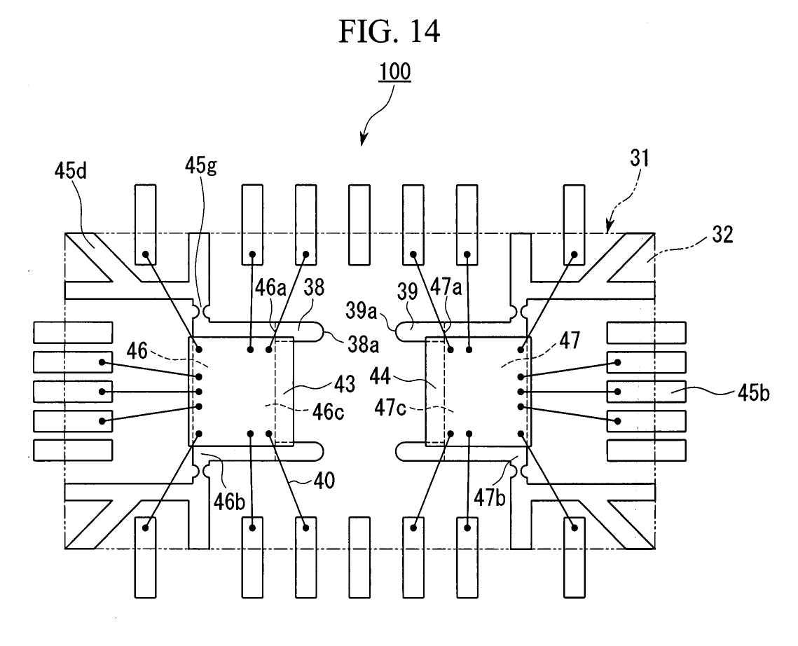

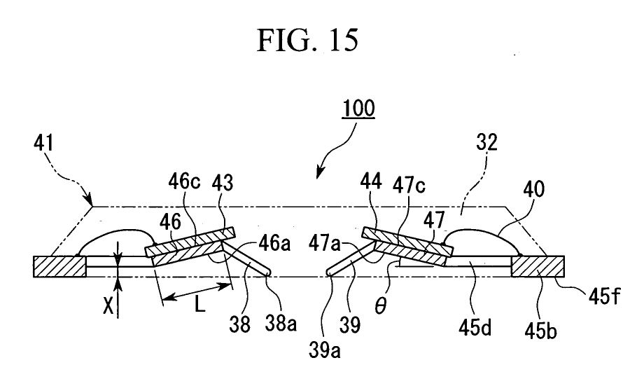

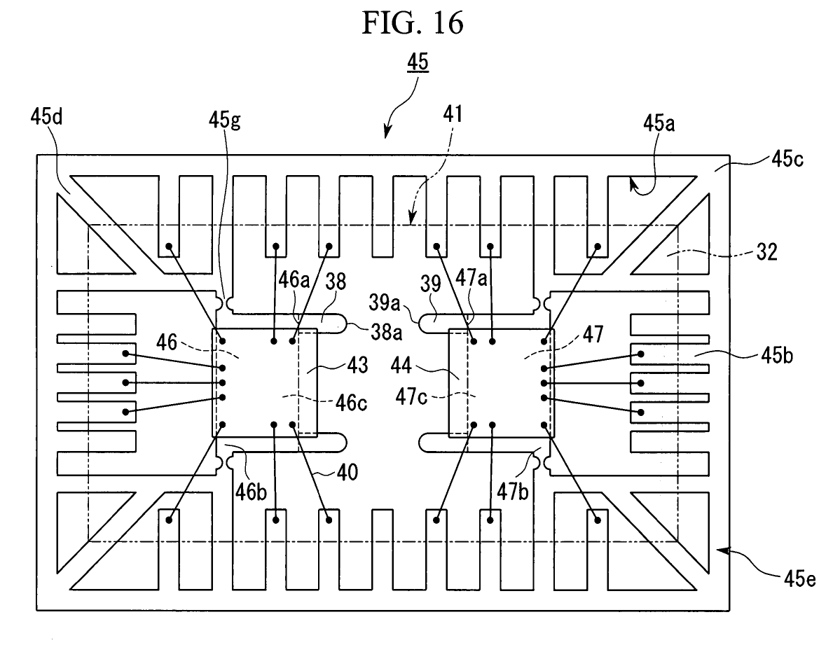

A third embodiment of the present invention will be described. FIG. 14 is a fragmentary plan view illustrating a sensor for sensing a physical quantity in accordance with a third preferred embodiment of the present invention. FIG. 15 is a fragmentary cross sectional elevation view illustrating the sensor of FIG. 14. FIG. 16 is a fragmentary plan view illustrating a lead frame to be used for forming the sensor of FIG. 14. A magnetic sensor 100 for sensing a physical quantity is shown in FIGS. 14 and 15. A lead frame 45 to be used for forming the sensor of FIGS. 14 and 15 is shown in FIG. 16. The magnetic sensor 100 includes a pair of magnetic sensor chips 43 and 44 that are tilted away from each other. The pair of magnetic sensor chips 43 and 44 senses or measures the direction and the magnitude of an external magnetic field. The magnetic sensor 100 is formed using the lead frame 45, which has a complex and fine structure. The magnetic sensor 100 includes a resin mold 31 that comprises a resin composition 32.

The lead frame 45 to be used for forming the magnetic sensor 100 includes two stages 46 and 47 on which the magnetic sensor chips 43 and 44 are mounted, respectively. The lead frame 45 further includes a frame 45e that mechanically supports the two stages 46 and 47. The frame 45e furthermore includes a rectangle frame portion 45a, a plurality of leads 45b and a plurality of modified connection leads 45d. The rectangle frame portion 45a has four sides that define an internal region. Thus, the internal region has a rectangle shape. The stages 46 and 47 are positioned in the internal region. The leads 45b extend inwardly from the four sides of the rectangle frame portion 45a. The modified connection leads 45d also extend from the rectangle frame portion 45a to the stages 46 and 47. The stages 46 and 47 are mechanically supported by the modified connection leads 45d.

Each of the stages 46 and 47 has a rectangle shape. The rectangle frame portion 45a has a first center line that is parallel to a longitudinal direction of the rectangle frame portion 45a. The rectangle frame portion 45a also has a second center line that is perpendicular to the first center line. Each of the stages 46 and 47 is disposed on the first center line. The stages 46 and 47 are also disposed symmetrically to each other with reference to a reflection-symmetric axis of the second center line. The stages 46 and 47 are distanced from the second center line. The stage 46 has a first side that is proximal to the stage 47. The stage 47 also has a second side that is proximal to the stage 46. The stage 46 has projecting portions 38 that extend from the first side toward the stage 47. The projecting portions 38 are distanced from the second center line. The stage 47 has projecting portions 39 that extend from the second side toward the stage 46. The projecting portions 39 are distanced from the second center line. The lead frame 45 has a first surface and a second surface 45f that opposes the first surface. The projecting portions 38 tilt from a plane that includes the stage 46 toward the second surface 45f. The projecting portions 39 tilt from another plane that includes the stage 37 toward the second surface 45f.

The modified connection leads 45d comprise suspending leads that suspend the stages 46 and 47 to the rectangle frame portion 45a. Each of the stages 46 and 47 is suspended from the rectangle frame portion 45a via a pair of the modified connection leads 45d. Each of the modified connection leads 45d has a twistable portion 45g that is connected with and adjacent to a side portion 46b or 47b of the stage 46 or 47. The twistable portion 45g is narrower than the modified connection lead 45d. The twistable portion 45g has recessed sides. The twistable portion 45g is twistable so as to tilt the stage 46 or 47.

The magnetic sensor 100 includes the leads 45b, the stages 46 and 47, the modified connection leads 45d connected with the stages 46 and 47, the magnetic sensor chips 43 and 44 mounted on the stages 46 and 47 respectively, wirings 40 that electrically connect the leads 45b and the magnetic sensor chips 43 and 44, and the resin mold 31 that encapsulates those elements. The resin mold 31 comprises the resin composition 32.

The rectangle frame portion 45 outside the resin mold 31 is then cut off and removed from the resin mold 31. The outside portions of the leads 45b and the modified connection leads 45d are detruncated and removed from the resin mold 31, thereby completing the magnetic sensor 100.

The magnetic sensor 100 may have a rectangle shape in plan view of a first dimension of 2.0-5.5/typical=4.2 mm and a second dimension of 2.0-5.5/typical=4.2 mm. Each of the stages 46 and 47 may have a square shape in plan view of a dimension of 0.6-2.5/typical=1.5 mm. Each of the stages 46 and 47 has a slope angle of 10-30 degrees. Each of the magnetic sensor chips 43 and 44 has a square shape in plan view of a dimension of 0.8-2.6/typical=1.5 mm. The modified connection leads 45d define small gaps that are adjacent to the modified connection leads 45d. For example, the leads 45b have a thickness of approximately 0.15 mm. The modified connection leads 45d have a thickness of approximately 0.075 mm. The small gaps adjacent to the modified connection leads 45d have a dimension “X” of approximately 0.075 mm.

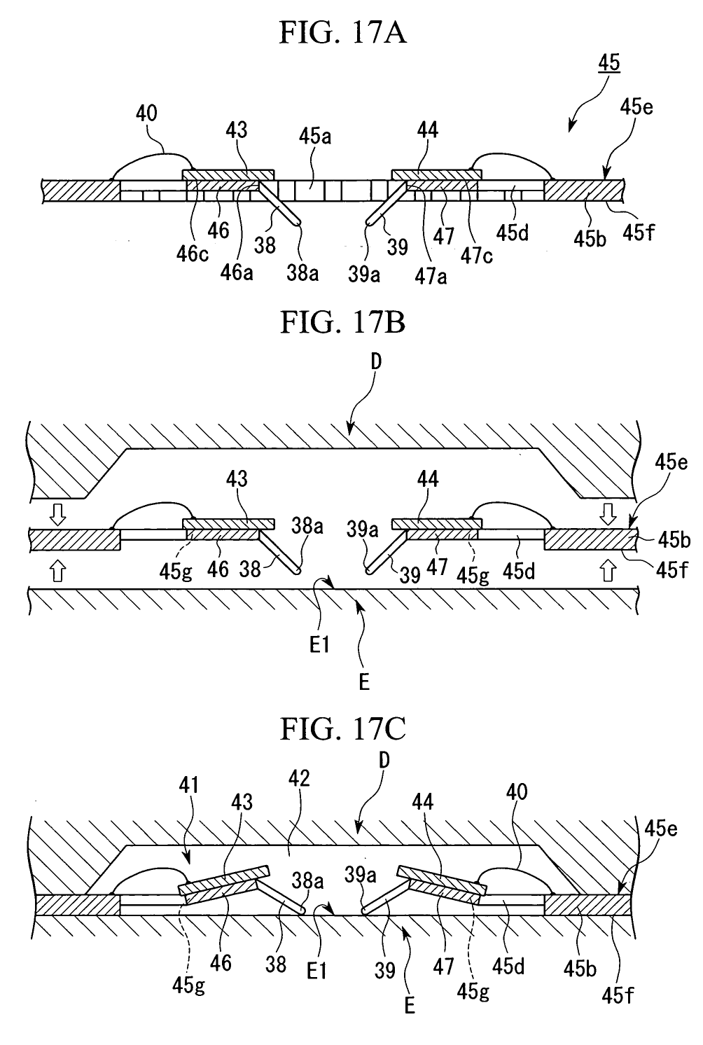

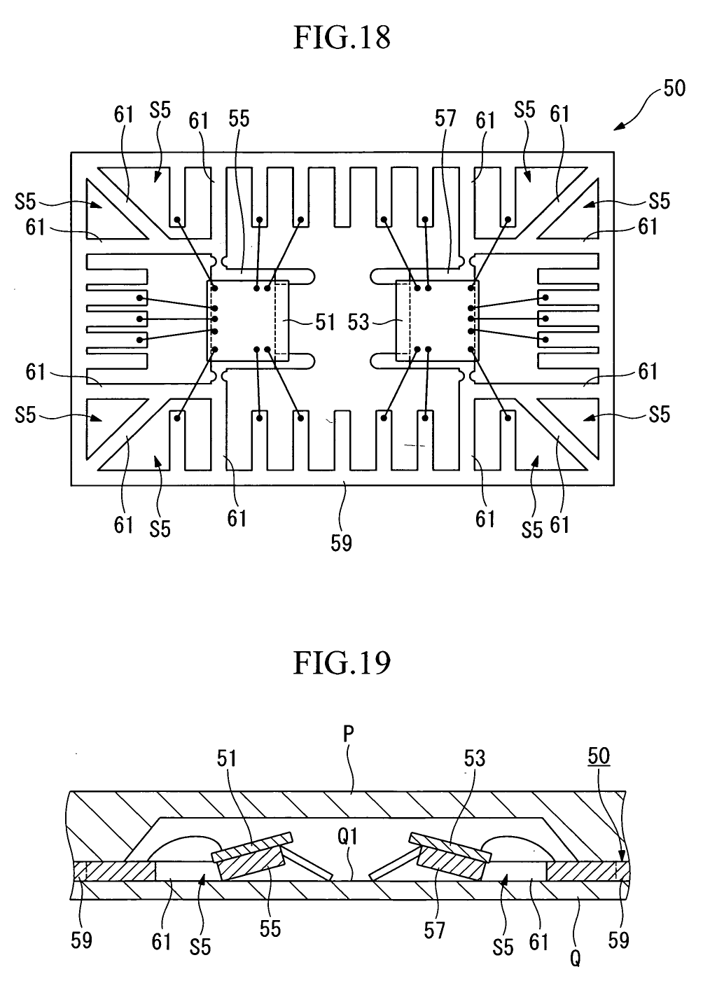

The magnetic sensor 100 may be formed by the following processes. FIG. 17A is a fragmentary cross sectional elevation view illustrating the lead frame in a step involved in a method of forming the sensor by using the lead frame of FIG. 16 in accordance with the third embodiment of the present invention. FIG. 17B is a fragmentary cross sectional elevation view illustrating the lead frame in another step involved in a method of forming the sensor by using the lead frame of FIG. 16 in accordance with the third embodiment of the present invention. FIG. 17C is a fragmentary cross sectional elevation view illustrating the lead frame in still another step involved in a method of forming the sensor by using the lead frame of FIG. 16 in accordance with the third embodiment of the present invention.

As shown in FIG. 17A, a metal plate is processed through press working or etching process to prepare the lead frame 45. The magnetic sensor chips 43 and 44 are bonded to the stages 46 and 47. The magnetic sensor chips 43 and 44 are electrically connected to the leads 45b.

As shown in FIG. 17B, the lead frame 45 is placed between paired dies “D” and “E”. The die “D” moves toward the counterpart die “E” and the flat surface “E1” of the die “E” pushes the projecting portions 38 or 39, whereby the twistable portions 45g of the modified connection leads 45d are twisted and the stages 46 and 47 with the magnetic sensor chips 43 and 34 are tilted. Small gaps are formed around the modified connection leads 45d. Other small gaps are formed between the stages 46 and 47 and the flat surface “E1” of the die “E”.

As shown in FIG. 17C, an injection molding process is performed to inject a molten resin into a cavity defined by the combined dies “D” and “E” to form the resin mold 31 that encapsulates the leads 45b, the stages 46 and 47, and the magnetic sensor chips 43 and 44. The resin mold 31 may comprise the resin composition 32 that comprises an epoxy resin and a filler mixed in the epoxy resin. The filler may preferably comprise silica particles that have a spherical shape of a maximum particle size of 30-50 micrometers and an average particle size of 10-30 micrometers. More preferably, the average particle size is 20 micrometers. The resin composition 32 may comprise 10 percent by weight of the epoxy resin and 90 percent by weight of the filler. The molten resin of the resin composition 32 is injected at an ordinal pressure of 9.8 MPa into the cavity. This pressure prevents the molten resin when injected from causing any substantive damage to the magnetic sensor chips 3 and 4. The filler that comprises the spherical particles of the above-described particle size permits the molten resin to fill up the small gaps around the modified connection leads 45d, thereby forming the resin mold 31 that is free of any voids. The rectangle frame portion 45 outside the resin mold 31 is then cut off and removed from the resin mold 31. The outside portions of the leads 45b and the modified connection leads 45d are detruncated and removed from the resin mold 31, thereby completing the magnetic sensor 100.

As described above, scaling down the sensor scales down the gaps around the modified connection leads 45d and the other gaps adjacent to the stages 46 and 47. In accordance with the third embodiment, however, the filler comprises the spherical particles of the maximum particle size of 30-50 micrometers and the average particle size of 10-30 micrometers. The resin composition including this filler permits the molten resin when injected under ordinal pressure to fill up the small gaps around the modified connection leads 45d and the other small gaps adjacent to the stages 46 and 47, thereby forming the resin mold 31 that is free of any voids without causing any substantive damage to the magnetic sensor chips 43 and 44.

The void-free resin mold 32 provides heat radiativity and an electrical insulation property to the magnetic sensor 100. The void-free resin mold 32 protects the magnetic sensor chips from mechanical impact and moisture. Thus, the use of the resin composition 32 for the resin mold 31 allows the sensor to be scaled down without causing the above-described disadvantages.

The resin composition 32 for the resin mold 31 may be applicable to any type of device that needs the resin mold that encapsulates the device. The sensor to be encapsulated by the resin mold may include a sensor chip mounted on a non-sloped stage that extends in the plane that includes the leads.

In accordance with the first embodiment, the magnetic sensor for sensing the azimuth and the magnitude of geomagnetism is provided. It is possible as a modification for the above-described resin composition to encapsulate another sensor for sensing at least the direction, the azimuth or the orientation of a physical quantity in the three dimensional space. Typical examples of the physical quantity include magnetic field, acceleration and other vector quantities. It is possible for the above-described resin composition to encapsulate an acceleration sensor chip that senses the direction and the magnitude of acceleration.

As used herein, the directional terms “up, down, inward, outward, forward, rearward, above, downward, perpendicular, vertical, horizontal, below, and transverse” as well as any other similar directional terms refer to those directions of an apparatus equipped with the present invention. Accordingly, these terms, as utilized to describe the present invention should be interpreted relative to an apparatus equipped with the present invention.

The term “rectangle” as used herein means a shape that has four straight sides and four right angles. The term “square” as used means a shape that has four sides of the same length and four right angles. The term “oblong” means a shape that has two long sides and two short sides and four right angles. Thus, the term “rectangle” includes the term “square” and the term “oblong”.

The term “physical quantity” as used herein typically means a vector quantity. The term “physical quantity” may include a scalar quantity, the vector quantity and a tensor quantity.

The terms of degree such as “generally”, “substantially,” “about,” and “approximately” as used herein mean a reasonable amount of deviation of the modified term such that the end result is not significantly changed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A lead frame comprising:
a frame body that defines an internal region;
a plurality of leads that extend from the frame body;
a first stage disposed in the internal region; and
a first modified connection lead structure comprising a flexible portion that is connected to the first stage and at least one modified connection lead that connects the flexible portion to the frame body and has sloped side walls.

2. The lead frame according to claim 1, wherein the at least one modified connection lead has a width that increases in a direction of thickness of the at least one modified connection lead.

3. The lead frame according to claim 2, wherein the at least one modified connection lead further has a first surface that is adjacent to the sloped side walls and separates the sloped side walls from each other.

4. The lead frame according to claim 3, wherein the at least one modified connection lead has a generally trapezoidal shape in cross section.

5. The lead frame according to claim 1, wherein the flexible portion has a reference axial line on which the flexible portion is configured to be bendable.

6. The lead frame according to claim 5, wherein the flexible portion has a width “W1” that is defined as a dimension on the reference axial line, and the width “W I satisfies conditions given by 0.5×t≦W1≦3.0×t, where “t” is the thickness of the flexible portion on the reference axial line.

7. The lead frame according to claim 6, wherein the flexible portion has at least one through hole that penetrates the flexible portion, and the at least one through hole is positioned on the reference axial line.

8. The lead frame according to claim 7, wherein the flexible portion has an effective width “Weffect” that is given by a subtraction of a sum of dimension of the at least one through hole on the reference axial line from the width “W1”, and the effective width “Weffect” satisfies conditions given by 0.5×t≦“Weffect”≦2.0×t, where “t” is the thickness of the flexible portion on the reference axial line.

9. The lead frame according to claim 8, wherein the at least one through hole has sloped side walls.

10. The lead frame according to claim 9, wherein the at least one through hole has a width that decreases in a direction of depth of the at least one through hole.

11. The lead frame according to claim 7, wherein the flexible portion has a thin portion that is thinner than the remaining portion of the flexible portion, and the thin portion extends along the reference axial line and has sloped side walls and the at least one through hole.

12. A sensor comprising:
a plurality of leads that extend in a first plane;
a first stage that extends in a second plane that tilts from the first plane;
a first sensor chip that is supported on the first stage; and
a first modified connection lead structure comprising a flexible portion that is adjacent to the first stage and at least one modified connection lead that connects the flexible portion to the flexible portion, the at least one modified connection lead having sloped side walls.

13. The sensor according to claim 12, wherein the at least one modified connection lead has a width that increases in a direction of thickness of the at least one modified connection lead.

14. The sensor according to claim 13, wherein the at least one modified connection lead further has a first surface that is adjacent to the sloped side walls and separates the sloped side walls from each other.

15. The sensor according to claim 14, wherein the at least one modified connection lead has a generally trapezoidal shape in cross section.

16. The sensor according to claim 12, wherein the flexible portion has a reference axial line and has a width “W1” that is defined as a dimension on the reference axial line, and the width “W1” satisfies conditions given by 0.5×t≦W1≦3.0×t, where “t” is the thickness of the flexible portion on the reference axial line.

17. The sensor according to claim 16, wherein the flexible portion has at least one through hole that penetrates the flexible portion, and the at least one through hole is positioned on the reference axial line.

18. The sensor according to claim 17, wherein the flexible portion has an effective width “Weffect” that is given by a subtraction of a sum of dimension of the at least one through hole on the reference axial line from the width “W1”, and the effective width “Weffect” satisfies conditions given by 0.5×t≦“Weffect”≦2.0×t, where “t” is the thickness of the flexible portion on the reference axial line.

19. The sensor according to claim 18, wherein the at least one through hole has sloped side walls.

20. The sensor according to claim 19, wherein the at least one through hole has a width that decreases in a direction of depth of the at least one through hole.

21. The sensor according to claim 17, wherein the flexible portion has a thin portion that is thinner than the remaining portion of the flexible portion, and the thin portion extends along the reference axial line and has sloped side walls and the at least one through hole.

22. The sensor according to claim 12, further comprising: a resin composition that encapsulates the plurality of leads, the first stage, the first sensor chip and the first modified connection lead, the resin composition comprising:
a resin material; and
a filler mixed in the resin material, the filler comprising particles having a maximum particle size of 30-50 micrometers and an average particle size of 10-30 micrometers.

23. The sensor according to claim 22, wherein the particles have a spherical shape.
